(19) United States
(12) Patent Application Publication
(10) Pub. No.: US 2025/0245729 A1
(43) Pub. Date: Jul. 31, 2025

(54) SYSTEMS AND METHODS FOR ITEM RECOMMENDATIONS BASED ON IMAGES

(71) Applicant: Walmart Apollo, LLC, Bentonville, AR (US)

(72) Inventors: Ramin Giahi, Rego Park, NY (US); Jianpeng Xu, Cupertino, CA (US); Najmeh Forouzandehmehr, Sunnyvale, CA (US); Morteza Farrokhsiar, San Francisco, CA (US); Evren Korpeoglu, San Jose, CA (US); Kannan Achan, Saratoga, CA (US)

(21) Appl. No.: 19/029,686

(22) Filed: Jan. 17, 2025

Related U.S. Application Data
(60) Provisional application No. 63/627,524, filed on Jan. 31, 2024.

(51) Int. Cl. G06Q 30/0601; G06V 10/82

(52) U.S. Cl. CPC G06Q 30/0631; G06Q 30/0633; G06V 10/82

(57) ABSTRACT

Systems and methods for providing item recommendations based on item images or uploaded images are disclosed. In some embodiments, a disclosed method includes: receiving, from a computing device, a recommendation request for recommending items to a customer; determining an anchor image based on the recommendation request; generating at least one query based on the anchor image; generating, using a language model, textual recommendation data based on the at least one query; generating, using at least one machine learning model, at least one ranked list of recommended items based on the textual recommendation data; and transmitting to the computing device the at least one ranked list of recommended items to be displayed to the customer.

### TECHNICAL FIELD

This application claims benefit to U.S. Provisional Application Ser. No. 63/627,524, entitled “SYSTEMS AND METHODS FOR ITEM RECOMMENDATIONS BASED ON IMAGES,” filed on Jan. 31, 2024, the disclosure of which is incorporated herein by reference in its entirety.

### TECHNICAL FIELD

This application relates generally to item recommendations and, more particularly, to systems and methods for providing item recommendations based on item images or uploaded images.

### BACKGROUND

Item recommendation tasks in e-commerce industry are essential to improve user experiences by recommending items to users. Different types of recommendations can be used to address use cases under various aspects of the relatedness, such as similar item (SI) recommendation, complementary item (CI) recommendation and complete the look (CTL). Existing recommendation systems focus on textual information of an anchor item and textual inputs provided by customers. But not every item has enough relevant textual information, and not every customer has time and convenience to input textual information. As such, it is challenging yet desirable to provide accurate and relevant recommendations based on other data types like images.

### SUMMARY

The embodiments described herein are directed to systems and methods for providing item recommendations based on item images or uploaded images.

In various embodiments, a system including a non-transitory memory configured to store instructions thereon and at least one processor is disclosed. The at least one processor is operatively coupled to the non-transitory memory and configured to read the instructions to: receive, from a computing device, a recommendation request for recommending items to a customer; determine an anchor image based on the recommendation request; generate at least one query based on the anchor image; generate, using a language model, textual recommendation data based on the at least one query; generate, using at least one machine learning model, at least one ranked list of recommended items based on the textual recommendation data; and transmit to the computing device the at least one ranked list of recommended items to be displayed to the customer.

In various embodiments, a computer-implemented method is disclosed. The computer-implemented method includes: receiving, from a computing device, a recommendation request for recommending items to a customer; determining an anchor image based on the recommendation request; generating at least one query based on the anchor image; generating, using a language model, textual recommendation data based on the at least one query; generating, using at least one machine learning model, at least one ranked list of recommended items based on the textual recommendation data; and transmitting to the computing device the at least one ranked list of recommended items to be displayed to the customer.

In various embodiments, a non-transitory computer readable medium having instructions stored thereon is disclosed. The instructions, when executed by at least one processor, cause at least one device to perform operations including: receiving, from a computing device, a recommendation request for recommending items to a customer; determining an anchor image based on the recommendation request; generating at least one query based on the anchor image; generating, using a language model, textual recommendation data based on the at least one query; generating, using at least one machine learning model, at least one ranked list of recommended items based on the textual recommendation data; and transmitting to the computing device the at least one ranked list of recommended items to be displayed to the customer.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured for providing item recommendations based on item images or uploaded images, in accordance with some embodiments of the present teaching;

FIG. 2 is a block diagram of an item recommendation computing device, in accordance with some embodiments of the present teaching;

FIG. 3 is a block diagram illustrating various portions of a system for providing item recommendations based on item images or uploaded images, in accordance with some embodiments of the present teaching;

FIG. 4 illustrates an exemplary process for generating ranked item recommendation, in accordance with some embodiments of the present teaching;

FIGS. 5-6 illustrate exemplary processes for generating textual recommendation data, in accordance with some embodiments of the present teaching;

FIGS. 7-8 illustrate exemplary processes for generating textual recommendation data and corresponding item recommendations, in accordance with some embodiments of the present teaching;

FIG. 9 is a flowchart illustrating an exemplary method for providing item recommendations based on item images or uploaded images, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

One objective of the present teaching is to generate and provide item recommendations based on images of anchor items or images uploaded by customers. In some embodiments, a disclosed system utilizes a multimodal pipeline to provide recommendations to a customer given an anchor image. The anchor image may be an image of a product item in a homepage, a cart page, a catalog webpage, an item webpage, a search results webpage, or a post-transaction webpage. The anchor image may also be an image uploaded by the customer.

In some embodiments, a system provides recommendations based on the image information, as well as user need and catalog data. In some examples, the system first converts the anchor image to textual information, and then generate a query based on the textual information. The query may be used as input to a language model to generate textual recommendation data. The system can provide one or more types of recommendations together, including e.g. similar item (SI) recommendations to recommend items similar to the anchor item, complementary item (CI) recommendations to recommend items that can complement the usage of the anchor item, and complete the look (CTL) recommendations to recommend items that can complete an entire outfit or fashion style of the customer with the anchor item. In some embodiments, the query may be different for different kinds of recommendations. The textual recommendation data may include different data for different queries given a same anchor image and a same anchor item.

In some examples, the language model is a large language model, which can generate the textual recommendation data based on the query and other textual data related to the anchor item, e.g. product details of the anchor item in an item page. In some embodiments, one or more filtering and/or review processes may be implemented at various stages to identify and/or prevent generation of undesirable content by the large language model or any other model. For example, one or more filtering processes may be applied to identify, remove, and/or otherwise eliminate undesirable content such as inappropriate content, offensive images, restricted images, etc. Although specific embodiments are discussed herein, it will be appreciated that any suitable filtering may be applied at any suitable steps of the disclosed methods.

In some embodiments, the system can retrieve and rank items based on the textual recommendation data directly. In some embodiments, the system can first convert the textual recommendation data to image data, and then use the image data to retrieve and rank items. In both scenarios, a ranked list of recommended items can be provided to the customer in form of links, images and/or item icons.

Furthermore, in the following, various embodiments are described with respect to systems and methods for providing item recommendations based on item images or uploaded images are disclosed. In some embodiments, a disclosed method includes: receiving, from a computing device, a recommendation request for recommending items to a customer; determining an anchor image based on the recommendation request; generating at least one query based on the anchor image; generating, using a language model, textual recommendation data based on the at least one query; generating, using at least one machine learning model, at least one ranked list of recommended items based on the textual recommendation data; and transmitting to the computing device the at least one ranked list of recommended items to be displayed to the customer.

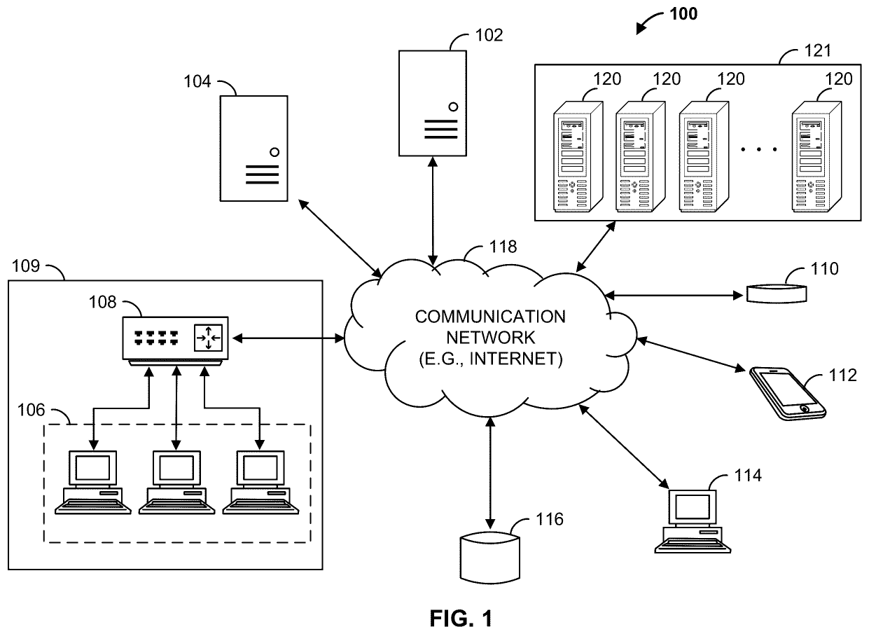

Turning to the drawings, FIG. 1 is a network environment 100 configured for providing item recommendations based on item images or uploaded images, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, an item recommendation computing device 102, a server 104 (e.g., a web server or an application server), a cloud-based engine 121 including one or more processing devices 120, workstation(s) 106, a database 116, and one or more user computing devices 110, 112, 114 operatively coupled over the network 118. The item recommendation computing device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the item recommendation computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the item recommendation computing device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or apps providing one or more products or services. In some examples, the item recommendation computing device 102, the processing devices 120, and/or the server 104 are operated by a retailer, and the multiple user computing devices 110, 112, 114 are operated by customers, associates and/or managers of the retailer. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the item recommendation computing device 102 over the communication network 118. The workstation(s) 106 may send data to, and receive data from, the item recommendation computing device 102. For example, the workstation(s) 106 may transmit data identifying items purchased by a customer at the store 109 to the item recommendation computing device 102. The workstation(s) 106 may also transmit other data related to the store 109 to the item recommendation computing device 102.

Although FIG. 1 illustrates three user computing devices 110, 112, 114, the network environment 100 can include any number of user computing devices 110, 112, 114. Similarly, the network environment 100 can include any number of the item recommendation computing devices 102, the processing devices 120, the workstations 106, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, each of the multiple user computing devices 110, 112, 114 may be operable to view, access, and interact with a website, such as a retailer's website, hosted by the server 104. The server 104 may capture user session data related to a customer's activity (e.g., interactions) on the website.

In some examples, a customer may operate one of the user computing devices 110, 112, 114 to initiate a web browser that is directed to the website hosted by the server 104. The customer may, via the web browser, view item advertisements for items displayed on the website, and may click on item advertisements, for example. The website may capture these activities as user session data, and transmit the user session data to the item recommendation computing device 102 over the communication network 118. The website may also allow the customer to add one or more of the items to an online shopping cart, and allow the customer to perform a “checkout” of the shopping cart to purchase the items. In some examples, the server 104 transmits purchase data identifying items the customer has purchased from the website to the item recommendation computing device 102.

In some examples, a customer may go to a store, e.g. the store 109 for purchasing items. The customer may use some payment method, e.g. a credit card or a payment app, at the store 109 to purchase one or more items. The workstation(s) 106 in the store 109 may capture these activities as in-store purchase data, and transmit the in-store purchase data to the item recommendation computing device 102 over the communication network 118, together with other store related data.

In some examples, the item recommendation computing device 102 may receive a recommendation request for recommending items to a customer of a retailer from the server 104. The recommendation request may be sent standalone or together with data associated with the customer's interaction with a website of the retailer, e.g. an anchor item to be displayed to the customer via the website or a user interface. In response, the item recommendation computing device 102 generates a ranked list of recommended items based on the anchor item using one or more models.

In some examples, the item recommendation computing device 102 may execute one or more models (e.g., programs or algorithms), such as a machine learning model, deep learning model, statistical model, etc., to generate a ranked list of recommended items to advertise to the customer (i.e., item recommendations). The item recommendation computing device 102 may generate and transmit the item recommendations to the server 104 over the communication network 118, and the server 104 may display one or more of the recommended items on the website to the customer. For example, the server 104 may display the recommended items to the customer on a homepage, a cart page, a catalog webpage, an item webpage, a search results webpage, a post-transaction webpage (e.g. a thank you page) of the website (e.g., as the customer browses those respective webpages), or another user interface.

In one example, a customer selects an item on a website hosted by the server 104, e.g. by clicking on the item to view its product description details, by adding it to shopping cart, or by purchasing it. The server 104 may treat the item as an anchor item or query item for the customer, and send a recommendation request to the item recommendation computing device 102. In response to receiving the request, the item recommendation computing device 102 may execute the one or more processors to determine recommended items that are related to the anchor item in various manners, and transmit the recommended items to the server 104 to be displayed together with the anchor item to the customer.

In another example, a customer submits a search query on a website hosted by the server 104, e.g. by entering a query in a search bar. The server 104 may send a recommendation request to the item recommendation computing device 102. In response to receiving the request, the item recommendation computing device 102 may execute the one or more processors to first determine search results including items matching the search query, and then determine recommended items that are related to one or more top items in the search results and recommend additional items based on the top items. The item recommendation computing device 102 may transmit the recommended items to the server 104 to be displayed together with the search results to the customer.

In some embodiments, the item recommendation computing device 102 is further operable to communicate with the database 116 over the communication network 118. For example, the item recommendation computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the item recommendation computing device 102, in some examples, the database 116 can be a local storage device, such as a hard drive, a non-volatile memory, or a USB stick. The item recommendation computing device 102 may store online purchase data received from the server 104 in the database 116. The item recommendation computing device 102 may receive in-store purchase data and store related data from the store 109 and store them in the database 116. The item recommendation computing device 102 may also receive from the server 104 user session data identifying events associated with browsing sessions, and may store the user session data in the database 116. The item recommendation computing device 102 may also compute recommendation data related to a ranked list of recommended items, and may store the recommendation data in the database 116.

In some examples, the item recommendation computing device 102 generates and/or updates different models (e.g., machine learning models, deep learning models, statistical models, algorithms, etc.) for providing item recommendations based on item images or uploaded images. The item recommendation computing device 102 may generate training data for the models based on historical user session data, purchase data, image data, recommendation data and simulated labels. The item recommendation computing device 102 trains the models based on their corresponding training data, and stores the models in a database, such as in the database 116 (e.g., a cloud storage). The models, when executed by the item recommendation computing device 102, allow the item recommendation computing device 102 to determine item recommendations for one or more items to advertise to a customer.

In some examples, the item recommendation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the item recommendation computing device 102 may generate ranked item recommendations for items to be displayed on the website.

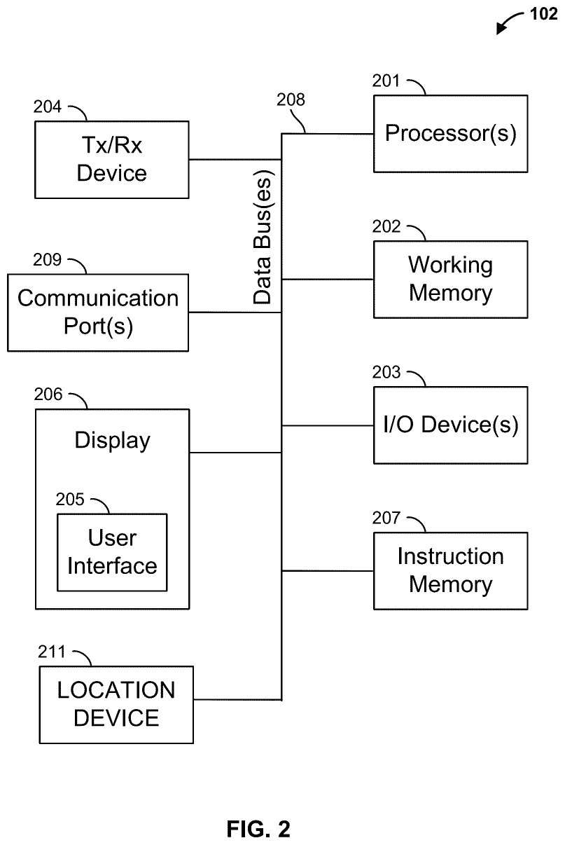

FIG. 2 illustrates a block diagram of an item recommendation computing device, e.g. the item recommendation computing device 102 of FIG. 1, in accordance with some embodiments of the present teaching. In some embodiments, each of the item recommendation computing device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the item recommendation computing device 102 can be combined, omitted, and/or replicated. In addition, it will be appreciated that additional elements other than those illustrated in FIG. 2 can be added to the item recommendation computing device 102.

As shown in FIG. 2, the item recommendation computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the item recommendation computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the item recommendation computing device 102 can include a single memory unit configured to operate as both instruction memory and working memory. Further, although embodiments are discussed herein including non-volatile memory, it will be appreciated that the item recommendation computing device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the item recommendation computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the item recommendation computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the item recommendation computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the item recommendation computing device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the item recommendation computing device 102 may determine a local geographical area (e.g., town, city, state, etc.) of its position.

In some embodiments, the item recommendation computing device 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

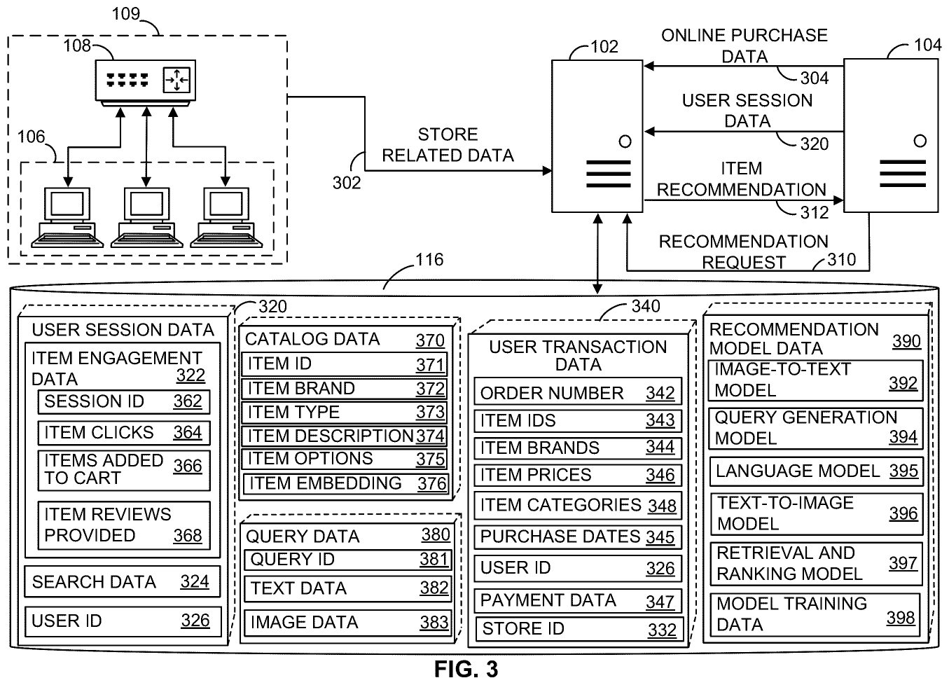

FIG. 3 is a block diagram illustrating various portions of a system for providing item recommendations based on item images or uploaded images, e.g. the system shown in the network environment 100 of FIG. 1, in accordance with some embodiments of the present teaching. As indicated in FIG. 3, the item recommendation computing device 102 may receive user session data 320 from the server 104, and store the user session data 320 in the database 116. The user session data 320 may identify, for each user (e.g., customer), data related to that user's browsing session, such as when browsing a retailer's webpage hosted by the server 104.

In some examples, the user session data 320 may include item engagement data 322, search data 324, and user ID 326 (e.g., a customer ID, retailer website login ID, a cookie ID, etc.). The item engagement data 322 may include one or more of a session ID 362 (i.e., a website browsing session identifier), item clicks 364 identifying items which a user clicked (e.g., images of items for purchase, keywords to filter reviews for an item), items added-to-cart 366 identifying items added to the user's online shopping cart, provided item reviews 368 identifying product reviews provided by users. The search data 324 may identify one or more searches conducted by a user during a browsing session (e.g., a current browsing session).

The item recommendation computing device 102 may also receive online purchase data 304 from the server 104, which identifies and characterizes one or more online purchases, such as purchases made by the user and other users via a retailer's website hosted by the server 104. The item recommendation computing device 102 may also receive store related data 302 from the store 109, which identifies and characterizes one or more in-store purchases. In some embodiments, the store related data 302 may also indicate other information about the store 109.

The item recommendation computing device 102 may parse the store related data 302 and the online purchase data 304 to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, a user ID 326 for the user making the corresponding purchase, payment data 347 indicating payment methods and related information (e.g. emails associated with payment) for corresponding online orders, and store ID 332 for the corresponding in-store purchase, or for the pickup store or shipping-from store associated with the corresponding online purchase.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), item options 375 (e.g., item colors, sizes, flavors, etc.), and item embedding 376 representing the item in an embedding space.

The database 116 may also store query data 380, which may identify one or more features of a plurality of queries submitted by users on the website. The query data 380 may include, for each of the plurality of queries, a query ID 381 identifying a query previously submitted by users, text data 382 identifying textual information associated with the query, and image data 383 identifying image information associated with the query.

The database 116 may also store recommendation model data 390 identifying and characterizing one or more models and related data for providing item recommendations. For example, the recommendation model data 390 may include: an image-to-text model 392, a query generation model 394, a language model 395, a text-to-image model 396, a retrieval and ranking model 397, and model training data 398.

The image-to-text model 392 may be used to convert image data to text data, e.g. converting an anchor image to textual information associated with the image. In some embodiments, the image-to-text model 392 includes a machine learning model, e.g. a neural network, trained to extract and/or generate textual data based on images. For example, the image-to-text model 392 may be trained based on pairwise image-text data from product images, product titles, product descriptions from product catalog data of a retailer. The generated text data can describe content of the corresponding image, in consideration of contextual information in and outside the corresponding image.

The query generation model 394 may be used to generate a query, e.g. based on the text data generated by the image-to-text model 392. In some embodiments, the query is generated based on a caption for the anchor image. In some embodiments, the query is generated in form of a question. In some examples, different questions are generated for different kinds of recommendations, e.g. SI recommendations, CI recommendations, or CTL recommendations. One or more kinds of recommendations may be generated and provided to a customer together, given an anchor image. The kinds of recommendations may be determined based on the use cases. In some embodiments, the query may also be generated based on inputs from a customer, e.g. the customer may ask a question associated with the anchor image. The query may be generated based on or directly using the question of the customer.

The query generated by the query generation model 394 may be used as an input to the language model 395, which may include a natural language model or a large language model used to understand the query and generate textual relevant recommendations. In general, a large language model (LLM) can acquire these abilities by learning statistical relationships from text documents during a computationally intensive self-supervised and semi-supervised training process. In some examples, LLMs are artificial neural networks following a transformer architecture. In some embodiments, the language model 395 is used to generate the textual relevant recommendations based on both the query and some product related textual data, e.g. product details of the anchor item. The textual relevant recommendations may be used to retrieve items for recommendation.

The text-to-image model 396 may be used to convert text data to image data, e.g. converting the textual relevant recommendations generated by the language model 395 to images. In some embodiments, the text-to-image model 396 includes a machine learning model, e.g. a deep learning network, trained to transform a text prompt to an image. For example, the text-to-image model 396 may be trained based on pairwise image-text data from product images, product titles, product descriptions from product catalog data of a retailer, or based on large volumes of images generated with their titles. The generated image data may be used to retrieve items for recommendation.

The retrieval and ranking model 397 may be used to retrieve and rank recommended items based on the textual relevant recommendations generated by the language model 395 directly, or based on the image data generated by the text-to-image model 396. In some embodiments, the retrieval and ranking model 397 includes a retrieval model configured to search an item database or item catalog based on the textual relevant recommendations or the image data. The search results will include relevant items each associated with a relevance score higher than a predetermined threshold. In some embodiments, the retrieval and ranking model 397 also includes a ranking model configured to rank the retrieved items based on their respective relevance scores. In some embodiments, the ranking is performed based on a predetermined weight that balances relevance and diversity. In some embodiments, the retrieval and ranking model 397 is a single machine learning model trained to perform retrieval and ranking together, to generate a ranked list of recommended items.

The model training data 398 may include training data utilized for training one or more of the image-to-text model 392, the query generation model 394, the language model 395, the text-to-image model 396 and the retrieval and ranking model 397. In some examples, the model training data 398 may include, but not limited to, data related to a plurality of anchor image samples and recommendation samples each associated with a label score. The label score may be determined based on historical interaction data of a plurality of customers regarding the recommendation sample. The model training data 398 may be used to train a machine learning model to optimize an objective function based on optimized hyperparameters. In some examples, the objective function is computed based on a plurality of ranking differences each being a difference between a first ranking and a second ranking for an anchor image sample. Each of the first ranking and the second ranking is a ranking of the recommendation samples paired to the anchor image sample. The first ranking of the recommendation samples is determined based on the machine learning model being trained. The second ranking of the recommendation samples is determined based on their respective label scores.

In some examples, the item recommendation computing device 102 receives a recommendation request 310 from the server 104. The recommendation request 310 may be associated with at least one anchor item or query item to be displayed to a user, or associated with an image uploaded by a user. In some embodiments, the item recommendation computing device 102 may use either a product image of the anchor item or the uploaded image as an anchor image to generate one or more queries, each for a corresponding type of recommendations. Based on the one or more queries, the item recommendation computing device 102 may generate textual recommendation data using a language model. The item recommendation computing device 102 may generate, using at least one machine learning model, item recommendation 312 indicating a ranked list of recommended items, based on the textual recommendation data directly or based on images generated from the textual recommendation data. The at least one machine learning model may include any model in the recommendation model data 390. In response to the recommendation request 310, the item recommendation computing device 102 transmits the item recommendation 312 to the server 104 to be displayed to the customer, e.g. together with the at least one anchor item.

In some embodiments, the item recommendation computing device 102 may assign one or more of the above described operations to a different processing unit or virtual machine hosted by one or more processing devices 120. Further, the item recommendation computing device 102 may obtain the outputs of the these assigned operations from the processing units, and generate the ranked item recommendations based on the outputs.

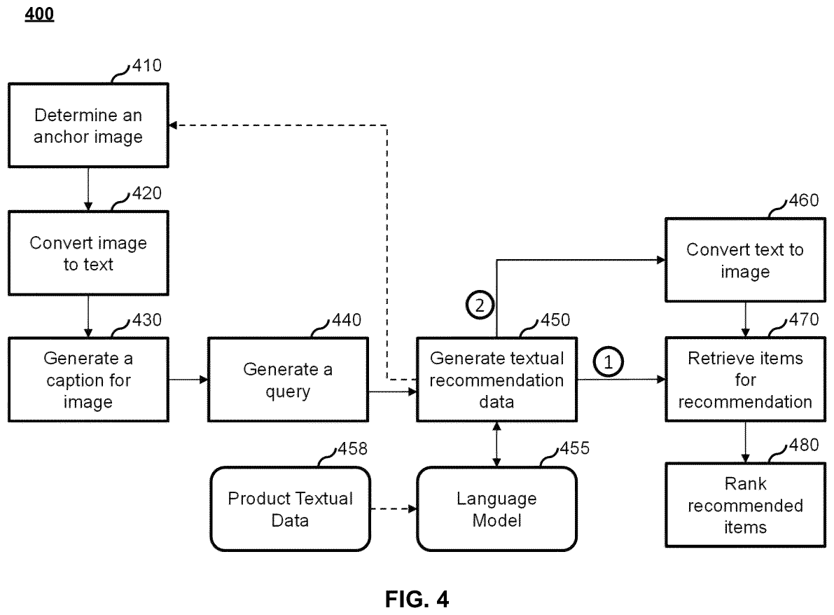

FIG. 4 illustrates an exemplary process 400 for generating ranked item recommendation, in accordance with some embodiments of the present teaching. In some embodiments, the process 400 can be carried out by one or more computing devices, such as the item recommendation computing device 102, and/or the cloud-based engine 121 of FIG. 1.

As shown in FIG. 4, the process 400 starts from operation 410, where an anchor image is determined, e.g. based on a recommendation request. In some embodiments, the recommendation request is for recommending items to a customer of a retailer, e.g. via a website or app. In some examples, the anchor image may be a main image of a product item interesting to the customer, e.g. after the customer clicks the product item to go to a product page containing details of the product item on the website or app. The recommendation request is triggered by the customer's click.

In some examples, a product page includes different variants, e.g. different colors, sizes, capacities, etc., of a same product. Whenever a customer clicks a different variant, a difference list of recommended items may be generated and provided to the customer on the product page.

In some examples, a product item page includes an anchor item associated with multiple item images. One of the multiple item images is selected to be the anchor image. For example, the first image or a main image in the multiple item images is selected to be the anchor image for the anchor item.

In some examples, the anchor image may be an image uploaded by a customer seeking some recommendations related to an item in the image via the website or app. The recommendation request may be triggered by the uploading of the image.

At operation 420, the system may convert the anchor image to textual data, e.g. using the image-to-text model 392 in the database 116. For example, the system can automatically generate a detailed textual description of the content of the anchor image based on the image-to-text model 392. Optionally at operation 430, a caption is generated for the anchor image. The caption may be a short description including one or two sentences describing the anchor image. In some embodiments, the caption may be a shorter description than the textual data generated at the operation 420.

At operation 440, a query is generated based on the textual data generated at the operation 420 and/or the caption generated at the operation 430, e.g. using the query generation model 394 in the database 116. In some embodiments, the query includes one or more prompt questions to be input into a language model for generating recommendation data. In some examples, the prompt questions include: “What are three accessories for this item?” “Can you describe the product style?” “Can you extract the fashion style and products?”

In some embodiments, the query may be formed based on the textual data generated at the operation 420. In some embodiments, the query may be formed based on the caption generated at the operation 430, which is shorter and concise for the language model to understand. In some embodiments, the query may be formed based on inputs from the customer. For example, the customer may directly input some questions to ask about the anchor image, and the questions may be used as a query to be input to the language model.

In some embodiments, the query includes different prompt questions for different kinds of recommendations. In some examples, for SI recommendations, a prompt question may be: “What are your similar recommendations for the item in the image?” In some examples, for CI recommendations, a prompt question may be: “Can you recommend accessories for the item in the image?” In some examples, for CTL recommendations, a prompt question may be: “Can you recommend three accessories for this image to complete the look?”

As shown in FIG. 4, textual recommendation data is generated at operation 450, e.g. based on the query generated at the operation 440. The system in this example can utilize a language model 455 at the operation 450 to generate the textual recommendation data based on the query, which may be one or more prompt questions. The language model 455 may be the language model 395 in the database 116. In some examples, the language model 455 is a large language model pre-trained based on large volumes of natural language data. In some embodiments, the textual recommendation data may also be generated based on product textual data 458 like product details in a product item page. For example, based on inputs of both the query and the product textual data 458, the language model 455 can output textual relevant recommendations for the item in the anchor image.

In some embodiments, the textual relevant recommendations generated at the operation 450 may include different data for different queries corresponding to different kinds of recommendations. In some examples, the textual relevant recommendations may include one of SI recommendations, CI recommendations, or CTL recommendations. In some examples, the textual relevant recommendations may include multiple or all of the SI recommendations, CI recommendations, and CTL recommendations.

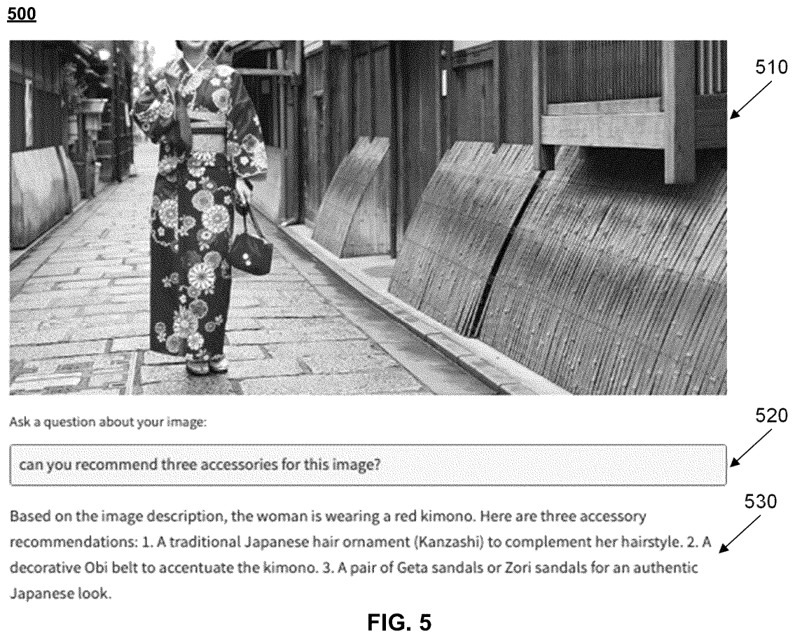

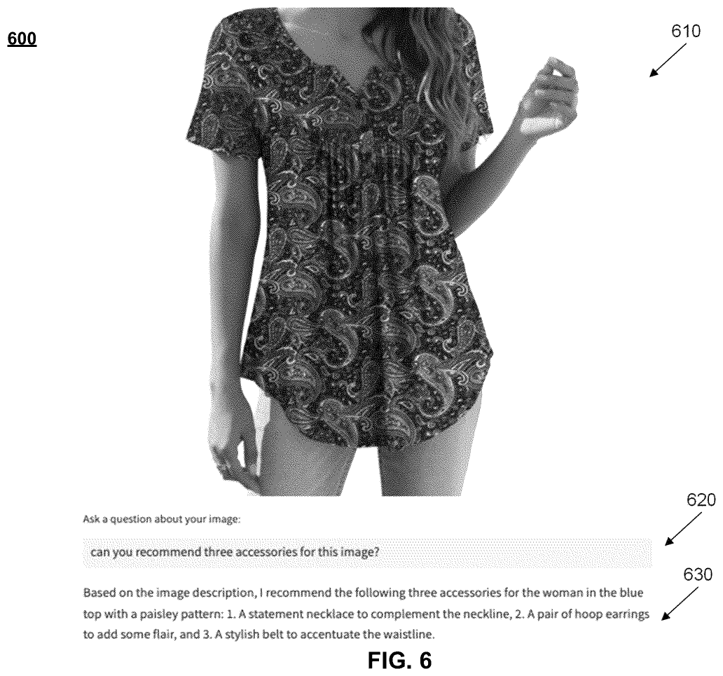

FIGS. 5-6 illustrate exemplary processes for generating textual recommendation data, in accordance with some embodiments of the present teaching. FIG. 5 illustrates an exemplary process 500 for generating textual recommendation data, in accordance with some embodiments of the present teaching. In some embodiments, the process 500 can be carried out by one or more computing devices, such as the item recommendation computing device 102, and/or the cloud-based engine 121 of FIG. 1. In some embodiments, the process 500 illustrates a use case of the operations 410-450 in FIG. 4.

As shown in FIG. 5, an image 510 is selected as an anchor image by the system. A query 520 is generated based on the image 510. In some examples, the query 520 may be generated automatically by the system based on texts extracted or transformed from the image 510, e.g. based on an image-to-text model. In some examples, the query 520 includes a question input by a user or customer. Then some textual recommendation data 530 is generated by the system based on the query 520 and the image 510. For example, the system can utilize a language model, e.g. a large language model, to generate the textual recommendation data 530 based on the query 520 and the texts extracted or transformed from the image 510.

In the example shown in FIG. 5, the query 520 includes a question of “can you recommend three accessories for this image?” Based on the query 520 and the textual data associated with the image 510, the system can understand this question indicates a request for CTL recommendations to complete the look of the dress in the image 510. As such, three accessory recommendations are provided in the textual recommendation data 530.

FIG. 6 illustrates an exemplary process 600 for generating textual recommendation data, in accordance with some embodiments of the present teaching. In some embodiments, the process 600 can be carried out by one or more computing devices, such as the item recommendation computing device 102, and/or the cloud-based engine 121 of FIG. 1. In some embodiments, the process 600 illustrates a use case of the operations 410-450 in FIG. 4.

As shown in FIG. 6, an image 610 is selected as an anchor image by the system. A query 620 is generated based on the image 610. In some examples, the query 620 may be generated automatically by the system based on texts extracted or transformed from the image 610, e.g. based on an image-to-text model. In some examples, the query 620 includes a question input by a user or customer. Then some textual recommendation data 630 is generated by the system based on the query 620 and the image 610. For example, the system can utilize a language model, e.g. a large language model, to generate the textual recommendation data 630 based on the query 620 and the texts extracted or transformed from the image 610.

In the example shown in FIG. 6, the query 620 includes a question of “can you recommend three accessories for this image?” Based on the query 620 and the textual data associated with the image 610, the system can understand this question indicates a request for CTL recommendations to complete the look of the dress in the image 610. As such, three accessory recommendations are provided in the textual recommendation data 630.

Referring back to FIG. 4, the textual recommendation data generated at the operation 450 can be used to retrieve items for recommendation at operation 470. In some embodiments, the items may be retrieved using a retrieval model, which may be part of the retrieval and ranking model 397 in the database 116.

There are two possible paths to go to the operation 470 from the operation 450, as shown in FIG. 4. In a first path, the textual recommendation data generated at the operation 450 is directly passed to the operation 470 to retrieve items for recommendation directly based on the textual recommendation data. In some examples, the textual outputs of the language model 455 can be directly used to search an item database or catalog to retrieve relevant items at the operation 470, e.g. based on keyword matching and/or embedding similarities.

In a second path, the textual recommendation data from the operation 450 is first sent to operation 460, where the textual recommendation data is converted to one or more images, e.g. using the text-to-image model 396 in the database 116. For example, the textual outputs of the language model 455 can be converted to images. The images are used to search an item database or catalog to retrieve relevant items at the operation 470. For example, an image similarity model may be used to find similar images corresponding to retrieved items from the item database, based on the generated images at the operation 460. The image similarity model may be a machine learning model pre-trained, e.g. based on item images or product images, to determine a level of similarity between any two images. The level of similarity may indicate whether and how much the content or main items included in the two images are similar to each other.

In some embodiments, the system can pick one of the two paths to go from the operation 450 to the operation 470. In some embodiments, the system can utilize both paths to go from the operation 450 to the operation 470. That is, at the operation 470, the items may be retrieved for recommendation based on a combination of the textual recommendation data generated at the operation 450 and the image(s) generated at the operation 460.

In some embodiments, each item retrieved at the operation 470 is associated with a relevance score. The relevance score indicates a level of relevance between the item and the textual recommendation data generated at the operation 450, and/or a level of relevance between the item and the image(s) generated at the operation 460. In some examples, the system may only retrieve items having relevance scores higher than a predetermined threshold at the operation 470. In some embodiments, a relevance score of a retrieved item is determined based on: a number of times the retrieved item was purchased in the past, its popularity, its review rating score, its probability to be clicked, etc. In some embodiments, customer interactions with retrieved and recommended items will be used as feedback to update the retrieval and/or ranking model, e.g. by updating the relevance scores of the retrieved and recommended items.

At operation 480, the retrieved items are ranked to generate at least one ranked list of recommended items. In some embodiments, the retrieved items may be ranked using a ranking model, which may be part of the retrieval and ranking model 397 in the database 116. In some examples, the retrieved items are ranked according to their respective relevance scores.

In some embodiments, multiple lists of recommended items are generated at the operation 480. Each ranked list of recommended items corresponds to a respective kind of recommendations to be displayed to a customer via a corresponding module. In various embodiments, a ranked list may be displayed in different formats e.g. as a list of links, a carousel of images, and/or a carousel of icons. Each link, image, or icon corresponds to a recommended item. For example, once a customer clicks on or selects one of the links, images or icons, the customer will be directed to a corresponding item page containing a corresponding recommended item. In some embodiments, the display format of a ranked list depends on the kind of recommendations corresponding to the ranked list. For example, a ranked list of recommended items for CTL recommendations may be displayed as a carousel of images. For example, a ranked list of recommended items for SI recommendations may be displayed as a list of links.

In some examples, after the system determines that the query was for multiple kinds of recommendations, e.g. SI and CTL, two recommendation lists are generated for SI and CTL recommendations, respectively. Both recommendation lists can be displayed together via two carousels on a same user interface to the customer. For example, one carousel may be titled as “Complete the look,” and the other carousel may be titled as “Similar items you might like.”

In some examples, the same user interface is an item page containing details of a product item and containing the anchor image being a main image of the product item. In some examples, the same user interface is a conversation window where the customer has uploaded the anchor image and is waiting for the item recommendations.

Optionally, the textual recommendation data generated at the operation 450 can be used as a feedback to one or more of the operations 410˜440. In some examples, the system can re-determine an anchor image at the operation 410 based on the feedback. In some examples, the system can re-generate text at the operation 420 and/or re-generate the caption for the anchor image at the operation 430, based on the feedback. In some examples, the system can use the feedback to re-generate the query and/or improve query generation quality in future at the operation 440. As such, the operations 410˜450 can form a loop which can iterate until a predetermined condition is satisfied according to some embodiments.

Although the process 400 described above are with reference to the illustrated flowchart in FIG. 4, it will be appreciated that many other ways of performing the operations associated with the process 400 can be used. For example, the order of some operations may be changed, and some of the operations described may be optional.

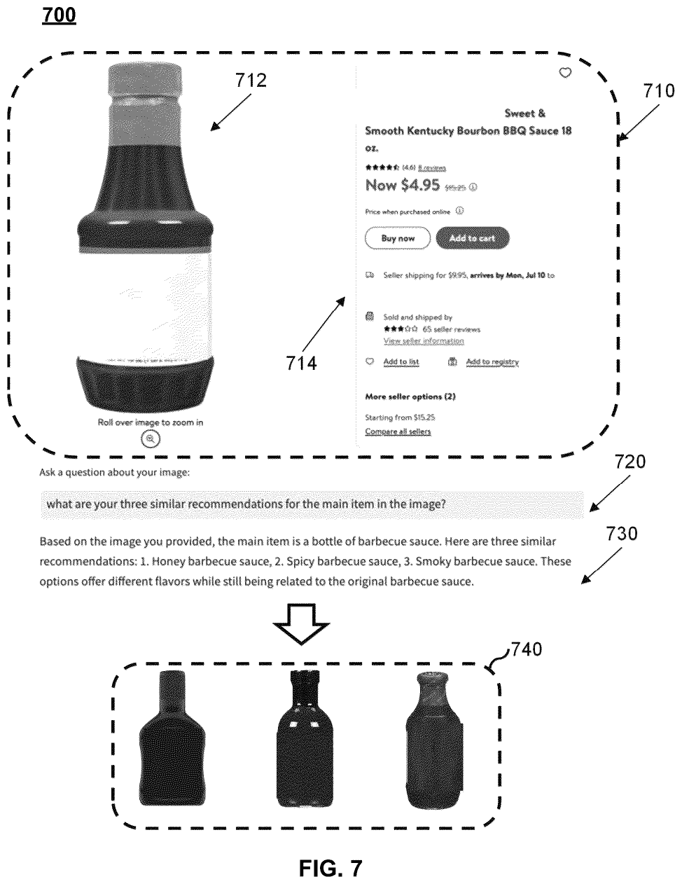

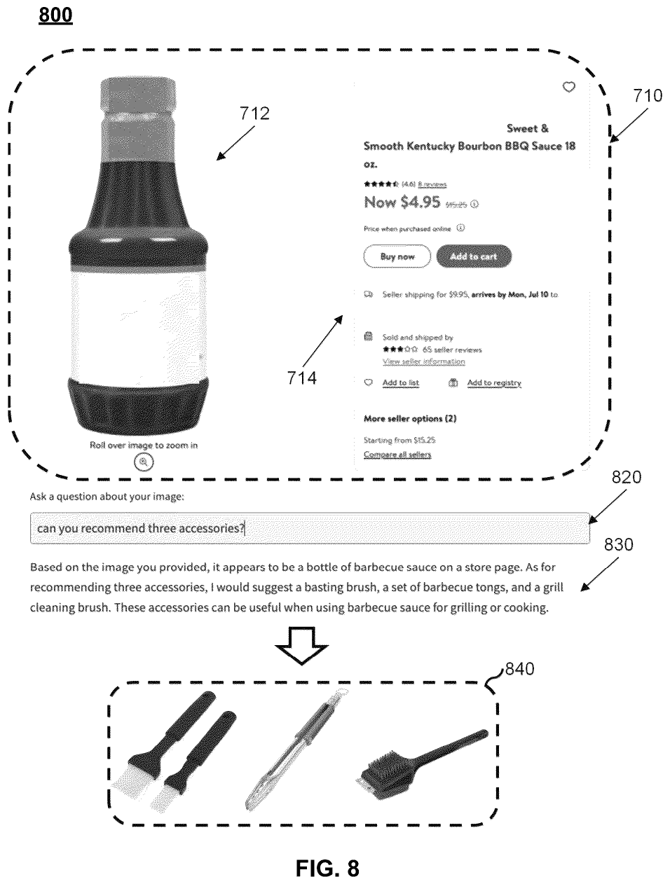

FIGS. 7-8 illustrate exemplary processes for generating textual recommendation data and corresponding item recommendations, in accordance with some embodiments of the present teaching. FIG. 7 illustrates an exemplary process 700 for generating textual recommendation data and corresponding item recommendations, in accordance with some embodiments of the present teaching. In some embodiments, the process 700 can be carried out by one or more computing devices, such as the item recommendation computing device 102, and/or the cloud-based engine 121 of FIG. 1. In some embodiments, the process 700 illustrates a use case of the operations 410-480 in FIG. 4.

As shown in FIG. 7, an image 710 is selected as an anchor image by the system, e.g. based on image from an item page or based on an upload of a customer. A query 720 is generated for the image 710. In some examples, the query 720 may be generated automatically by the system based on texts extracted or transformed from the image 710, e.g. based on an image-to-text model. In some examples, the query 720 includes a question input by a user or customer. Then some textual recommendation data 730 is generated by the system based on the query 720 and the image 710. For example, the system can utilize a language model, e.g. a large language model, to generate the textual recommendation data 730 based on the query 720 and the texts extracted or transformed from the image 710.

In the example shown in FIG. 7, the query 720 includes a question of “what are your three similar recommendations for the main item in the image?” In the example shown in FIG. 7, the image 710 includes not only an item image 712 but also some additional information 714. The query 720 is about the main item, which is the item image 712, in the image 710 here. As such, the system can treat the additional information 714 as noisy information to be ignored when generating the textual recommendation data 730.

In some embodiments, the system can first convert the entire image 710 to text data, and then ignore any text data corresponding to the additional information 714 based on the query 720. In some embodiments, the system can first identify and ignore the additional information 714 in the image 710 based on the query 720 (e.g. based on a user input), and then merely convert the item image 712 in the image 710 to text data.

In the example shown in FIG. 7, based on the query 720 and the textual data associated with the item image 712 in the image 710, the system can understand the query 720 indicates a request for SI recommendations to find similar items to the main item (a bottle of barbecue sauce) in the item image 712 of the image 710. As such, three similar recommendations are provided in the textual recommendation data 730. Based on the textual recommendation data 730, the system can retrieve and rank a list of recommended items 740 as shown in FIG. 7. In this example, the ranked list of recommended items 740 includes similar items (e.g. other barbecue sauces with similar bottle sizes) to the main item. In this example, the ranked list of the recommended items 740 are ranked according to their similarity scores to the main item, where a more similar recommended item to the main item would be placed at a higher rank in the list.

FIG. 8 illustrates an exemplary process 800 for generating textual recommendation data and corresponding item recommendations, in accordance with some embodiments of the present teaching. In some embodiments, the process 800 can be carried out by one or more computing devices, such as the item recommendation computing device 102, and/or the cloud-based engine 121 of FIG. 1. In some embodiments, the process 800 illustrates a use case of the operations 410-480 in FIG. 4.

In FIG. 8, the same image 710 is selected as an anchor image by the system as in FIG. 7. But a different query 820 from the query 720 is generated for the image 710 in FIG. 8. In some examples, the query 820 may be generated automatically by the system based on texts extracted or transformed from the image 710, e.g. based on an image-to-text model. In some examples, the query 820 includes a question input by a user or customer.

Then some textual recommendation data 830 is generated by the system based on the query 820 and the image 710. For example, the system can utilize a language model, e.g. a large language model, to generate the textual recommendation data 830 based on the query 820 and the texts extracted or transformed from the image 710. As discussed above, the system can treat the additional information 714 in the image 710 as noisy information to be ignored, and focus on the item image 712 in the image 710 when generating the textual recommendation data 830.

In the example shown in FIG. 8, the query 820 includes a question of “can you recommend three accessories?” In the example shown in FIG. 8, based on the query 820 and the textual data associated with the item image 712 in the image 710, the system can understand the query 820 indicates a request for CI recommendations to find complementary items to the main item (a bottle of barbecue sauce) in the item image 712 of the image 710. As such, three complementary recommendations or three accessories are provided in the textual recommendation data 830. Based on the textual recommendation data 830, the system can retrieve and rank a list of recommended items 840 as shown in FIG. 8. In this example, the ranked list of recommended items 840 includes complementary items (e.g. tools typically used in junction with the barbecue sauce) to the main item. In this example, the ranked list of the recommended items 840 are ranked according to their complementary scores to the main item, where a recommended item more often being used or purchased with the main item would be placed at a higher rank in the list.

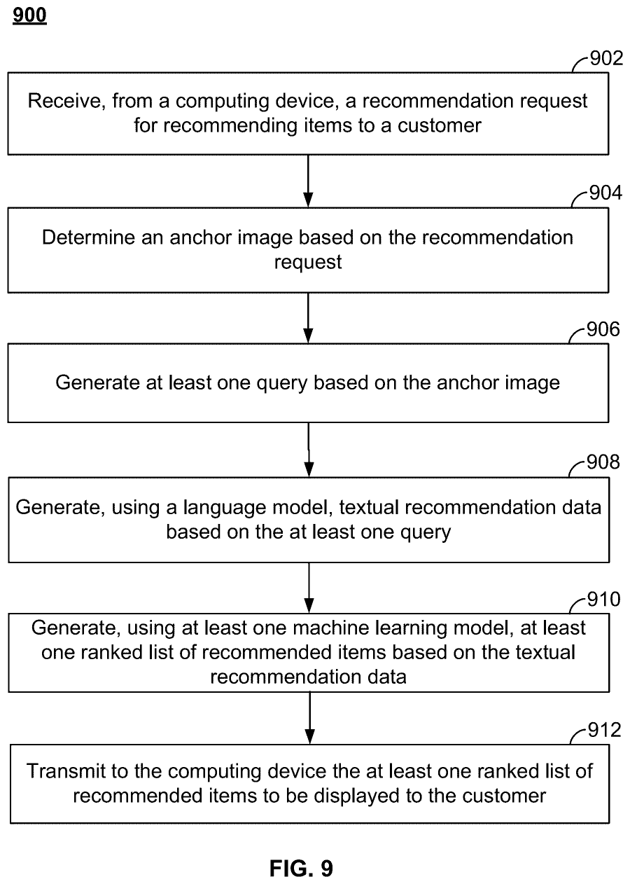

FIG. 9 is a flowchart illustrating an exemplary method 900 for providing item recommendations based on item images or uploaded images, in accordance with some embodiments of the present teaching. In some embodiments, the method 900 can be carried out by one or more computing devices, such as the item recommendation computing device 102 and/or the cloud-based engine 121 of FIG. 1. Beginning at operation 902, a recommendation request for recommending items to a customer is received from a computing device. At operation 904, an anchor image is determined based on the recommendation request. At operation 906, at least one query is generated based on the anchor image. At operation 908, textual recommendation data is generated using a language model based on the at least one query. At operation 910, at least one ranked list of recommended items is generated using at least one machine learning model based on the textual recommendation data. At operation 912, the at least one ranked list of recommended items is transmitted to the computing device, to be displayed to the customer.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a processor; and
a non-transitory memory storing instructions, that when executed, cause the processor to:
receive a recommendation request for recommending items to a customer,
determine an anchor image based on the recommendation request,
generate at least one query based on the anchor image,
generate, using a language model, textual recommendation data based on the at least one query,
generate, using at least one machine learning model, at least one ranked list of recommended items based on the textual recommendation data, and
transmit to a computing device the at least one ranked list of recommended items to be displayed to the customer.

2. The system of claim 1, wherein the anchor image is at least one of:
an image uploaded by the customer; or
an image of a product item with which the customer interacted on a webpage.

3. The system of claim 1, wherein the at least one query is generated based on:
converting the anchor image to textual data;
generating a caption describing the anchor image;
obtaining an input question from the customer; and
generate the at least one query based on: the textual data, the caption and the input question.

4. The system of claim 1, wherein:
the at least one query includes a plurality of prompt questions to be input into the language model for generating the textual recommendation data; and
the plurality of prompt questions are generated according to different types of recommendations associated with the recommendation request.

5. The system of claim 4, wherein:
the language model is a large language model pre-trained based on volumes of natural language data;
the textual recommendation data is generated based on the at least one query and product textual data on a product item page; and
the textual recommendation data includes different data for different prompt questions corresponding to the different types of recommendations.

6. The system of claim 4, wherein:
the at least one ranked list of recommended items includes a plurality of ranked lists of recommended items;
each ranked list of recommended items is generated for a prompt question corresponding to a respective type of the different types of recommendations; and
each ranked list of recommended items is to be displayed in a respective carousel of a same user interface showing the anchor image to the customer.

7. The system of claim 6, wherein each ranked list of recommended items is generated based on:
searching an item database to retrieve a plurality of items by comparing the textual recommendation data to item texts in the item database, wherein:
each of the plurality of items is associated with a relevance score indicating a degree of relevance between the item and the textual recommendation data based on the respective type of recommendation, and
the relevance scores associated with the plurality of items are higher than a predetermined threshold; and
ranking the plurality of items according to their respective relevance scores to generate the ranked list of recommended items.

8. The system of claim 6, wherein each ranked list of recommended items is generated based on:
converting the textual recommendation data to query images;
searching an item database to retrieve a plurality of items by comparing the query images to item images in the item database, wherein:
each of the plurality of items is associated with a relevance score indicating a degree of relevance between the item and the query images based on the respective type of recommendation, and
the relevance scores associated with the plurality of items are higher than a predetermined threshold; and
ranking the plurality of items according to their respective relevance scores to generate the ranked list of recommended items.

9. The system of claim 1, wherein the instructions, when executed, further cause the processor to:
generate a feedback signal based on the textual recommendation data; and
update, based on the feedback signal, at least one of: the anchor image or the at least one query.

10. A computer-implemented method, comprising:
receiving a recommendation request for recommending items to a customer;
determining an anchor image based on the recommendation request;
generating at least one query based on the anchor image;
generating, using a language model, textual recommendation data based on the at least one query;
generating, using at least one machine learning model, at least one ranked list of recommended items based on the textual recommendation data; and
transmitting to a computing device the at least one ranked list of recommended items to be displayed to the customer.

11. The computer-implemented method of claim 10, wherein generating the at least one query comprises:
converting the anchor image to textual data;
generating a caption describing the anchor image;
obtaining an input question from the customer; and
generate the at least one query based on: the textual data, the caption and the input question.

12. The computer-implemented method of claim 10, wherein:
the at least one query includes a plurality of prompt questions to be input into the language model for generating the textual recommendation data; and
the plurality of prompt questions are generated according to different types of recommendations associated with the recommendation request.

13. The computer-implemented method of claim 12, wherein:
the language model is a large language model pre-trained based on volumes of natural language data;
the textual recommendation data is generated based on the at least one query and product textual data on a product item page; and
the textual recommendation data includes different data for different prompt questions corresponding to the different types of recommendations.

14. The computer-implemented method of claim 12, wherein:
the at least one ranked list of recommended items includes a plurality of ranked lists of recommended items;
each ranked list of recommended items is generated for a prompt question corresponding to a respective type of the different types of recommendations; and
each ranked list of recommended items is to be displayed in a respective carousel of a same user interface showing the anchor image to the customer.

15. The computer-implemented method of claim 14, wherein each ranked list of recommended items is generated based on:
searching an item database to retrieve a plurality of items by comparing the textual recommendation data to item texts in the item database, wherein:
each of the plurality of items is associated with a relevance score indicating a degree of relevance between the item and the textual recommendation data based on the respective type of recommendation, and
the relevance scores associated with the plurality of items are higher than a predetermined threshold; and
ranking the plurality of items according to their respective relevance scores to generate the ranked list of recommended items.

16. The computer-implemented method of claim 14, wherein each ranked list of recommended items is generated based on:
converting the textual recommendation data to query images;
searching an item database to retrieve a plurality of items by comparing the query images to item images in the item database, wherein:
each of the plurality of items is associated with a relevance score indicating a degree of relevance between the item and the query images based on the respective type of recommendation, and
the relevance scores associated with the plurality of items are higher than a predetermined threshold; and
ranking the plurality of items according to their respective relevance scores to generate the ranked list of recommended items.

17. A non-transitory computer readable medium having instructions stored thereon, wherein the instructions, when executed by at least one processor, cause at least one device to perform operations comprising:
receiving a recommendation request for recommending items to a customer;
determining an anchor image based on the recommendation request;
generating at least one query based on the anchor image;
generating, using a language model, textual recommendation data based on the at least one query;
generating, using at least one machine learning model, at least one ranked list of recommended items based on the textual recommendation data; and
transmitting to a computing device the at least one ranked list of recommended items to be displayed to the customer.

18. The non-transitory computer readable medium of claim 17, wherein generating the at least one query comprises:
converting the anchor image to textual data;
generating a caption describing the anchor image;
obtaining an input question from the customer; and
generate the at least one query based on: the textual data, the caption and the input question.

19. The non-transitory computer readable medium of claim 17, wherein:
the at least one query includes a plurality of prompt questions to be input into the language model for generating the textual recommendation data; and
the plurality of prompt questions are generated according to different types of recommendations associated with the recommendation request.

20. The non-transitory computer readable medium of claim 19, wherein:
the language model is a large language model pre-trained based on volumes of natural language data;
the textual recommendation data is generated based on the at least one query and product textual data on a product item page;
the textual recommendation data includes different data for different prompt questions corresponding to the different types of recommendations;
the at least one ranked list of recommended items includes a plurality of ranked lists of recommended items;
each ranked list of recommended items is generated for a prompt question corresponding to a respective type of the different types of recommendations; and
each ranked list of recommended items is to be displayed in a respective carousel of a same user interface showing the anchor image to the customer.
